(19) United States
(12) Patent Application Publication
(10) Pub. No.: US 2025/0381756 A1
(43) Pub. Date: Dec. 18, 2025

(54) THICKENED ANTI-SLIP ELASTIC MAT

(71) Applicant: SUZHOU HRED MAT CO.,LTD, CHANGSHU (CN)

(72) Inventors: YIYANG XIA, CHANGSHU (CN); JIANDA DING, CHANGSHU (CN); JIANFEI XI, CHANGSHU (CN)

(21) Appl. No.: 19/080,205

(22) Filed: Mar. 14, 2025

(30) Foreign Application Priority Data
Jun. 14, 2024 (CN) 202421355352.4

(51) Int. Cl. B32B 5/18; B32B 5/32; B32B 37/06

(52) U.S. Cl. CPC B32B 5/18; B32B 5/32; B32B 37/06; B32B 2250/02; B32B 2307/72; B32B 2307/744; B32B 2398/20; B32B 2471/04

(57) ABSTRACT

Provided is a thickened anti-slip elastic mat, belonging to the technical field of ground mat products. The thickened anti-slip elastic mat includes: an upper surface layer, the upper surface layer being composed of one or more foaming layers; and a TPE non-slip layer, the TPE non-slip layer being compounded at a bottom of the upper surface layer through a film laminating process, an anti-slip pattern of the TPE non-slip layer being formed on a surface of one side of the TPE non-slip layer facing downwards in use by pressing, and the anti-slip pattern of the TPE non-slip layer being configured to enhance a friction force when the TPE non-slip layer is in contact with a horizontal plane.

### TECHNICAL FIELD

The present disclosure belongs to the technical field of ground mat products, and in particular to a thickened anti-slip elastic mat.

### BACKGROUND

In daily life, people often lay ground mats in places, including but not limited to, living rooms, bedrooms, kitchens, house entrances, as well as hotels, children's entertainment facilities, amusement parks and the like, so as to provide safety protection and improve indoor aesthetics. Moreover, ground mats can effectively scrape away mud, dust and moisture from the soles of shoes, thereby keeping the indoor ground clean. Because most existing ground mats have a certain degree of flexibility and elasticity, after a user treads or lies on a ground mat body, the ground mat can effectively relieve the blood circulation pressure on the feet and the whole body to reduce physical fatigue, thereby playing a role in resisting fatigue. Therefore, anti-slip ground mats with good shock-absorbing, anti-slip and safety protection properties are essential. However, existing ground mats generally have the problems of low structural strength, poor elasticity and buffering property, and poor anti-shock property. Moreover, after long-term use, existing ground mats have the defects of poor anti-slip effect and short product life.

Existing elastic ground mats can also be foamed and molded by an EVA material. Although the use of the elastic ground mats as substitutes for rubber mats can achieve certain non-slip and anti-slip effects, in fact, the non-slip property on the surface is poor, and a non-slip effect on the surface can be provided only by an embossed pattern. However, the embossed pattern concavely acts on the surface of the ground mat to form a concave-convex non-slip surface which has a limited non-slip effect. Moreover, the concave part is more susceptible to being filled with dirt, thereby shortening the service life while greatly reducing the non-slip function of the ground mat and causing poor safety, which is not conducive to wide promotion. Furthermore, the existing elastic ground mat is limited by the overall thickness, that is, the flexibility and rebound rate of the ground mat are positively correlated with the overall thickness. Due to the fact that a thickness of the existing elastic ground mat cannot achieve excellent flexibility and rebound ability, the functional comfort is poor, and the experience is relatively single. Therefore, how to effectively improve the flexibility and comfort of the elastic mat body and the treading rebound rate property is also a difficulty that urgently needs to be overcome in the current ground mat industry.

The thermoplastic elastomer (TPE) is a material having high elasticity, high strength and high rebound ability of rubber as well as injection molding characteristics, which has the advantages of environmental protection, no toxicity, safety, wide hardness range, excellent stainability, soft tactility and the like, and has better weather resistance, fatigue resistance and temperature tolerance, has excellent processing properties, is free of vulcanization, can be recycled to reduce the cost, can be formed by secondary injection molding, can be coated and bonded with matrix materials such as PP, PE, PC, PS and ABS, and can also be molded separately. Various elastic products made of the thermoplastic elastomer as an anti-slip material have the characteristics of good elasticity, good anti-slip effect, good toughness, strong tension, recyclability and reusability. However, the TPE material is not widely used for existing anti-slip elastic ground mat products. If a mat body bonding an EVA foaming material and the TPE material can be designed to achieve corresponding flexibility, rebound ability and anti-slip and non-slip functions, it not only effectively ensures excellent flexibility, rebound ability and functional comfort to improve the use experience, but also has excellent anti-slip and non-slip properties to further improve the safety in use.

### SUMMARY

The task of the present disclosure is to provide a thickened anti-slip elastic mat having a simple structure, good flexibility, a good buffering property and a wide application scope. By compound connection of a TPE non-slip layer at a bottom of an upper surface layer, the overall flexibility and elasticity and wear resistance of the elastic mat are effectively improved, and the elastic mat has an excellent anti-slip effect, has good comfort and safety in use, has a good elastic effect, and can effectively relieve human fatigue and thus has significant promotion significance.

The task of the present disclosure is completed as follows: A thickened anti-slip elastic mat includes: an upper surface layer, the upper surface layer being composed of one or more foaming layers; and a TPE non-slip layer, the TPE non-slip layer being compounded at a bottom of the upper surface layer through a film laminating process, an anti-slip pattern of the TPE non-slip layer being formed on a surface of one side of the TPE non-slip layer facing downwards in use by pressing, and the anti-slip pattern of the TPE non-slip layer being configured to enhance a friction force when the TPE non-slip layer is in contact with a horizontal plane.

Further, the foaming layer is one of an EVA foaming layer, a PE foaming layer, a TPE foaming layer, or a composite material foaming layer.

Further, the foaming layer has a plurality of foam pores, and open foaming bodies in communication with each other are formed among the foam pores; and a thickness of the open foaming body is 1 mm-5 mm, and a pore size of the foam pore is 50 μm-400 μm.

Further, a gram weight of the foaming layer is 60 g/m²-1000 g/m².

Further, the TPE non-slip layer is compounded at a lower part of the upper surface layer through a high-temperature film laminating process.

Further, an anti-slip coating is also coated on the surface of one side of the TPE non-slip layer facing downwards in use.

Further, a gram weight of the TPE non-slip layer is 100 g/m²-600 g/m².

Further, the foaming layer is integrally formed during foaming operation.

After adopting the above structure, the present disclosure has the following beneficial effects: Firstly, the TPE non-slip layer is compounded at the lower part of the upper surface layer through the film laminating process, so that the upper surface layer has excellent buffering and shock-absorbing functions to provide good human foot feel and lying comfort; the TPE non-slip layer made of a TPE material has excellent elasticity, flexibility, compatibility and tensile strength, so that the thickened elastic mat has the advantages of flexibility, elasticity, wear resistance, excellent anti-slip effect and the like; the elastic mat can be firmly attached to the ground to effectively prevent a mat body from slipping after being in direct contact with the ground so as to improve the safety in use, the use experience is good, and the human fatigue can be effectively relieved; and the elastic mat can be used as a splicing ground mat, a kitchen mat, a yoga mat, a door mat and other indoor ground mat products, has a wide application scope, also has the advantages of convenient preparation and low cost, is not prone to bacterial growth, and is beautiful and practical. Secondly, the TPE non-slip layer is compounded at the bottom of the upper surface layer through the high-temperature film laminating process, and the high-temperature film laminating process can ensure the advantages of strong adhesive strength, good heat resistance, strong chemical resistance and the like between two bonding layers; and the TPE non-slip layer is uniformly bonded and covered with the upper surface layer neatly and beautifully to effectively ensure the overall strength of the elastic mat and enable the elastic mat to have excellent waterproof and airtight properties, thereby improving the grip property and anti-slip ability of the elastic mat in this technical solution, and further ensuring the reliability in use. Thirdly, by additionally arranging the anti-slip pattern of the TPE non-slip layer and the anti-slip coating on the TPE non-slip layer, the friction force between the elastic mat and the ground can be further enhanced to achieve the dual-anti-slip property of the elastic mat body, thereby preventing the human body from slipping during treading, effectively ensuring the stability in use, and further improving the safety.

### BRIEF DESCRIPTION OF FIGURES

FIG. 1 is a side cross-sectional diagram according to an embodiment of the present disclosure; and

FIG. 2 is a schematic diagram of an overall structure according to the embodiment in FIG. 1.

### IN THE FIGURES

1: upper surface layer; 11: foaming layer; 2: TPE non-slip layer; 21: anti-slip pattern of TPE non-slip layer; and 22: anti-slip coating.

### DETAILED DESCRIPTION

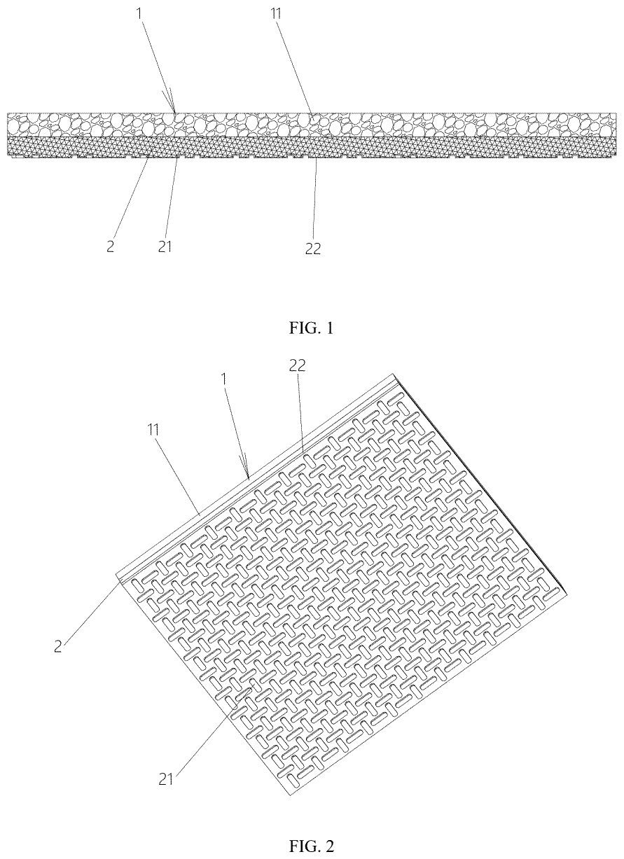

In the following description, any concept of directionality or orientation involving up, down, left, right, front and back is specific to the current position state shown in FIG. 1, and therefore cannot be understood as a special limitation on the technical solution provided by the present disclosure.

FIG. 1 and FIG. 2 show a thickened anti-slip elastic mat, including: an upper surface layer 1, the upper surface layer 1 being composed of one or more foaming layers 11 and one layer in this embodiment; and a TPE non-slip layer 2, the TPE non-slip layer 2 being compounded at a bottom of the upper surface layer 1 through a film laminating process. FIG. 1 is a side cross-sectional diagram according to an embodiment of the present disclosure. The upper surface layer 1 and the TPE non-slip layer 2 both have sheet structures, the upper surface layer 1 and the TPE non-slip layer 2 are bonded together to form a sheet body, namely an elastic mat body in this technical solution, and the upper surface layer 1 and the TPE non-slip layer 2 are formed as an integral component. Specifically, as shown in FIG. 1, when the elastic mat in this technical solution is in use, the TPE non-slip layer 2 is attached to a horizontal plane (mainly the ground) and serves to fix the mat body, and the upper surface layer 1 can be used for human foot treading or can be used for human lying and sitting when the elastic mat body in this technical solution is used as a yoga mat, a splicing mat, or the like.

The TPE non-slip layer 2 is made of a TPE material. The TPE is the abbreviation for thermoplastic elastomer, which is a type of polymer material that exhibits rubber elasticity at a room temperature and can be plasticized at a high temperature, and is composed of plastic segments (hard segments) and rubber segments (elastic soft segments) connected together. The TPE is a new type of polymer material that lies between rubber and resin, and has dual properties of rubber and plastic. Common TPE includes styrenes (SBS, SIS, SEBS, SEPS), olefins (TPO, TPV), dienes (TPB, TPI), amino esters (TPU), and the like. The TPE material has excellent elasticity, flexibility, compatibility and tensile strength, so that the TPE non-slip layer can provide flexibility, toughness, wear resistance, excellent anti-slip property and the like for the thickened anti-slip elastic mat in this technical solution. On the one hand, the elastic mat can quickly recover the deformation through excellent rebound ability after being pressed; and on the other hand, the elastic mat body has a stable and reliable anti-slip function, thereby ensuring the stability and safety in use.

Still referring to FIG. 1 and FIG. 2, an anti-slip pattern 21 of the TPE non-slip layer is also formed on a surface of one side of the TPE non-slip layer 2 facing downwards in use by pressing, the anti-slip pattern 21 of the TPE non-slip layer is configured to enhance a friction force when the TPE non-slip layer 2 is in contact with a horizontal plane, and the anti-slip pattern 21 of the TPE non-slip layer is formed as a convex structure on a lower surface of the TPE non-slip layer 2, thereby effectively ensuring the stable anti-slip effect of the elastic mat in this technical solution, and improving the comfort in use. Moreover, as shown in FIG. 1, the anti-slip pattern 21 of the TPE non-slip layer is formed by convex anti-slip strips that are arranged uniformly. Of course, a shape of the anti-slip pattern 21 of the TPE non-slip layer is not limited to this and can be designed in various types, such as a wrinkled surface, a corrugated surface with multiple grooves, a serrated surface, or any combined shape. Any change in shape construction falls within the scope of protection of this patent and will not be further described here.

It should be noted that the shape of the thickened anti-slip elastic mat in this technical solution according to the embodiment shown in FIG. 1 is a rectangular sheet shape, and certainly may also be any other shapes, including but not limited to, a rectangular circle, a triangle, a trapezoid, a character shape, a cartoon animal shape, an easily spliced shape, and the like. The shape can make corresponding changes according to actual usage requirements and production process requirements, all of which are within the scope of protection of the present disclosure.

The foaming layer 11 is one of an EVA foaming layer, a PE foaming layer, a TPE foaming layer, or a composite material foaming layer. The EVA material is an ethylene vinyl acetate copolymer, the PE material is polyethylene, the TPE (Thermoplastic Elastomer) is a thermoplastic elastomer material, and the composite material foaming layer can bond the EVA material, the PE material and the TPE material. In this embodiment, the foaming layer 11 is preferably an EVA foaming layer. As a cross-linked foaming material, the EVA has excellent flexibility, high flexibility, rebound ability, chemical corrosion resistance, vibration damping and sound insulation properties, and the like. Moreover, the EVA foaming layer can provide excellent rebound ability and anti-slip property for the elastic mat together with the TPE non-slip layer 2 with good flexibility, attaching effect and grip ability. Of course, the material of the foaming layer 11 is not limited to this, and the material can make corresponding changes according to corresponding usage requirements and production process requirements, all of which are within the scope of protection of the present disclosure.

The foaming layer 11 has a plurality of foam pores, and open foaming bodies in communication with each other are formed among the foam pores. A thickness of the open foaming body is 1 mm-5 mm, and a pore size of the foam pore is 50 μm-400 μm. It should be further noted that when the foaming layer 11 made of the EVA material in the present disclosure is prepared, materials such as calcium carbonate powder, foaming agent, bridging agent, zinc oxide, stearic acid and color particles can be added, where the calcium carbonate powder can be used for filling the foam pore to ensure that the foam pore does not deform; the foaming agent can promote the generation of gas during the foaming and molding of a stearic acid foaming layer, thereby increasing the elasticity of the foaming layer; the bridging agent is a cross-linking agent, which can enable the foaming layer to be cross-linked and molded; the zinc oxide serves as a heat transfer paste during rubber mixing to ensure consistent temperatures in all regions of the foaming layer during the foaming process, thereby shortening the vulcanization time while avoiding scorching or aging caused by local overheating of the foaming layer; in addition, the zinc oxide forms zinc soap under the action of the stearic acid, making the bridging agent more active; the stearic acid can serve as a demolding agent, and the product which is foamed in a mold can be quickly demolded by adding the stearic acid, thereby ensuring the integrity of the product during demolding; and the color particles are used for dyeing, and the desired color can be generated for the foaming layer 11 by adding the color particles.

A gram weight of the foaming layer 11 is 60 g/m²-1000 g/m². In an actual production process, based on considerations of wear resistance and comfort, the square gram weight of the foaming layer 11 can be adjusted, where the larger the square gram weight, the higher the compactness of the upper surface layer 1, and the better the wear resistance and foot feel, thereby ensuring the using effect.

The TPE non-slip layer 2 is compounded at a lower part of the upper surface layer 1 through a high-temperature film laminating process. The TPE non-slip layer 2 can be uniformly coated at the lower part of the upper surface layer 1 by way of high-temperature film laminating, thereby ensuring bonding firmness and high connection strength. Moreover, during the film laminating process, the temperature is generally controlled between 180° C. and 220° C. The high-temperature film laminating process can ensure the advantages of strong adhesive strength, good heat resistance, strong chemical resistance and the like between two bonding layers, ensure the overall strength of the elastic mat, and improve the reliability in use.

An anti-slip coating 22 is also coated on the surface of one side of the TPE non-slip layer 2 facing downwards in use. By arranging the anti-slip coating 22, the thickened anti-slip elastic mat in this technical solution is more wear-resistant and scrape-resistant, thereby further improving the reliability in use.

A gram weight of the TPE non-slip layer 2 is 100 g/m²-600 g/m². Similar to the foaming layer 11, based on considerations of rebound ability, wear resistance and comfort, the square gram weight of the TPE non-slip layer 2 can be adjusted, where the larger the square gram weight, the higher the compactness of the upper surface layer 1; and the TPE non-slip layer 2 can be thickened, thereby improving the overall elasticity, tensile strength and anti-slip property, and improving the comfort and safety in use.

The foaming layer 11 is integrally formed during foaming operation. The integrally formed foaming has higher strength and low cost, is favorable for mass production of the thickened anti-slip elastic mat in this technical solution, and can ensure the overall strength, and greatly improves the economic benefit of the elastic mat.

Referring to FIG. 1 and FIG. 2, the preparation and working principles of the technical solution provided by the present disclosure are briefly described. During preparation of the thickened anti-slip elastic mat, first, the foaming layer 11 is prepared through integrally formed foaming operation. If the upper surface layer 1 is composed of a plurality of foaming layers 11, the plurality of foaming layers 11 can be bonded through processes such as heat sealing. Then, a TPE anti-slip material can be compounded at the lower part of the upper surface layer 1 through high-temperature film laminating, and the corresponding anti-slip pattern 21 of the TPE non-slip layer is further formed by pressing, and then, the product in the corresponding shape is prepared by deep processing of the appearance of the product, thereby completing the preparation of the thickened anti-slip elastic mat. During use, the thickened anti-slip elastic mat can be directly laid on a horizontal plane, including but not limited to, the ground. The TPE material, the anti-slip pattern 21 of the TPE non-slip layer and the anti-slip coating 22 have excellent flexibility, wear resistance and anti-slip property, and the anti-slip property can be further improved by pressing the TPE. After the thickened anti-slip elastic mat is laid, the bonding property between the TPE non-slip layer 2 and the horizontal plane is good, and the overall structural strength is high, thereby preventing users from accidentally slipping and causing injury while using or walking over the mat body. Moreover, the thickened anti-slip elastic mat in this technical solution can be used as a splicing ground mat, a kitchen mat, a yoga mat, a door mat and other multiple products, and provides excellent rebound ability, wear resistance and scrape resistance, and has good tensile strength and buffering property, thereby further improving the comfort in use.

What is claimed is:

1. A thickened anti-slip elastic mat, comprising: an upper surface layer (1), the upper surface layer (1) being composed of one or more foaming layers (11); and a TPE non-slip layer (2), the TPE non-slip layer (2) being compounded at a bottom of the upper surface layer (1) through a film laminating process, an anti-slip pattern (21) of the TPE non-slip layer being formed on a surface of one side of the TPE non-slip layer (2) facing downwards in use by pressing, and the anti-slip pattern (21) of the TPE non-slip layer being configured to enhance a friction force when the TPE non-slip layer (2) is in contact with a horizontal plane.

2. The thickened anti-slip elastic mat according to claim 1, wherein the foaming layer (11) is one of an EVA foaming layer, a PE foaming layer, a TPE foaming layer, or a composite material foaming layer.

3. The thickened anti-slip elastic mat according to claim 1, wherein the foaming layer (11) has a plurality of foam pores, and open foaming bodies in communication with each other are formed among the foam pores; and a thickness of the open foaming body is 1 mm-5 mm, and a pore size of the foam pore is 50 μm-400 μm.

4. The thickened anti-slip elastic mat according to claim 2, wherein the foaming layer (11) has a plurality of foam pores, and open foaming bodies in communication with each other are formed among the foam pores; and a thickness of the open foaming body is 1 mm-5 mm, and a pore size of the foam pore is 50 μm-400 μm.

5. The thickened anti-slip elastic mat according to claim 1, wherein a gram weight of the foaming layer (11) is 60 g/m²-1000 g/m².

6. The thickened anti-slip elastic mat according to claim 1, wherein the TPE non-slip layer (2) is compounded at a lower part of the upper surface layer (1) through a high-temperature film laminating process.

7. The thickened anti-slip elastic mat according to claim 1, wherein an anti-slip coating (22) is also coated on the surface of one side of the TPE non-slip layer (2) facing downwards in use.

8. The thickened anti-slip elastic mat according to claim 1, wherein a gram weight of the TPE non-slip layer (2) is 100 g/m²-600 g/m².

9. The thickened anti-slip elastic mat according to claim 1, wherein the foaming layer (11) is integrally formed during foaming operation.
